(19) United States
(12) Patent Application Publication
(10) Pub. No.: US 2014/0127071 A1
(43) Pub. Date: May 8, 2014

(54) MANUFACTURING METHOD OF MAGNETIC REFRIGERATION MATERIAL

(71) Applicant: DENSO CORPORATION, Kariya-city (JP)

(72) Inventors: Tomonori Fujinaka, Obu-city (JP); Yasuo Kitou, Okazaki-city (JP)

(73) Assignee: DENSO CORPORATION, Kariya-city (JP)

(21) Appl. No.: 14/071,981

(22) Filed: Nov. 5, 2013

(30) Foreign Application Priority Data
Nov. 7, 2012 (JP) 2012-245565

(51) Int. Cl. H01F 1/01

(52) U.S. Cl. CPC H01F 1/015
USPC 419/27; 419/1

(57) ABSTRACT

In a manufacturing method of a magnetic refrigeration material, a powder material made of La (Fe, Si)₁₃ is molded by applying a pressure equal to or higher than 286 MPa and heating at a temperature equal to or lower than 600 degrees Celsius. Thus, a molded product of the magnetic refrigeration material is produced.

### CROSS REFERENCE TO RELATED APPLICATION

This application is based on Japanese Patent Application No. 2012-245565 filed on Nov. 7, 2012, the disclosure of which is incorporated herein by reference.

### TECHNICAL FIELD

The present disclosure relates to a manufacturing method of a magnetic refrigeration material.

### BACKGROUND

A magnetic refrigeration material is, for example, used in a refrigerant cycle for air conditioning, a cold storage, refrigeration, or the like. As a refrigeration technology considering environmental issues, a magnetic refrigeration technology, which is clean and has high energy efficiency, has been researched and developed.

In regard to the magnetic refrigeration technology, when a magnetic field is externally applied to a magnetic refrigeration material, the magnetic refrigeration material generates a magneto-caloric effect. For example, a La (Fe, Si)₁₃-based material has been known as a magnetic refrigeration material generating a high magneto-caloric effect.

For example, JP2007-291437A proposes to form a magnetic refrigeration material into a micro-channel shape to effectively perform heat exchange between the magnetic refrigeration material and a refrigerant.

### SUMMARY

In a manufacturing process of the micro-channel magnetic refrigerant material, so as to generate a crystalline structure of La (Fe, Si)₁₃, which easily exert the magneto-caloric effect, a material is powdered after a melting, quenching and heat-treatment process. The powdered material is then molded by sintering. However, a part of the La (Fe, Si)₁₃ structure is broken during the sintering, and α-Fe is deposited. In such a case, the magneto-caloric effect is likely to be decreased.

It is an object of the present disclosure to provide a manufacturing method of a magnetic refrigeration material, in which molding is performed while restricting the decrease in magneto-caloric effect.

According to an aspect of the present disclosure, in a manufacturing method of a magnetic refrigeration material, a powder material made of La (Fe, Si)₁₃ is molded by applying a pressure equal to or higher than 286 MPa at a heating temperature equal to or lower than 600 degrees Celsius (° C.) to produce a molded product of the magnetic refrigeration material.

In the manufacturing method, the powder material of the magnetic refrigeration material is molded by applying the pressure while heating at the temperature which is in a range where the amount of deposition of α-Fe is relatively small. Therefore, since the amount of deposition of the α-Fe is decreased, it is less likely that the magneto-caloric effect will be decreased. Since the heating temperature is low so as to reduce the deposition of the α-Fe, progression of the sintering reaction is slow. However, since the powder material is applied with a high pressure, the molding of the powder material is realized.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a schematic diagram for explaining a manufacturing process of a micro-channel heat exchanger according to an example of an embodiment of the present disclosure;

FIG. 2 is a schematic diagram for explaining a manufacturing process of a micro-channel heat exchanger according to another example of the embodiment of the present disclosure;

FIG. 3 is a graph illustrating an X-ray diffraction measurement result for determining a deposition state of α-Fe;

FIG. 4 is a graph illustrating a relationship between a treatment temperature and a magneto-caloric effect;

FIG. 5 is a graph illustrating a relationship between an applied pressure and a filling rate; and

FIG. 6 is a diagram illustrating a state of mixing of a metal powder and a material as a modification of the present disclosure.

### DETAILED DESCRIPTION

Embodiments of a manufacturing method of a magnetic refrigeration material will be hereinafter described.

As the magnetic refrigeration material, a LaFe₁₃-based material having a crystalline structure of NaZn₁₃ is employed. The LaFe₁₃-base material is provided by La (Fe_{z}, Si₁₋ₓ)₁₃, in which x satisfies 0≦x≦1. For example, x is a predetermined value. In examples, which will be described later, x is 0.88.

To mold the magnetic refrigeration material into an arbitrary shape, for example, the magnetic refrigeration material is powdered once and then molded into a desired shape. In such a process, if the powdered material is heated to 700 degrees Celsius (° C.) or more, α-Fe is deposited and a sintering reaction of the powdered material is advanced. As a result, the magnetic refrigeration material having the desired shape is produced. However, since the α-Fe is deposited, the magneto-caloric effect is likely to decrease. To address this matter, the present disclosure provides a method of molding the magnetic refrigeration material without heating the material at a high temperature.

In the examples described hereinafter, micro-channel heat exchangers using a magnetic refrigeration material were manufactured.

<Manufacturing of Micro-Channel Heat Exchanger Using Magnetic Refrigeration Material>

### Example 1

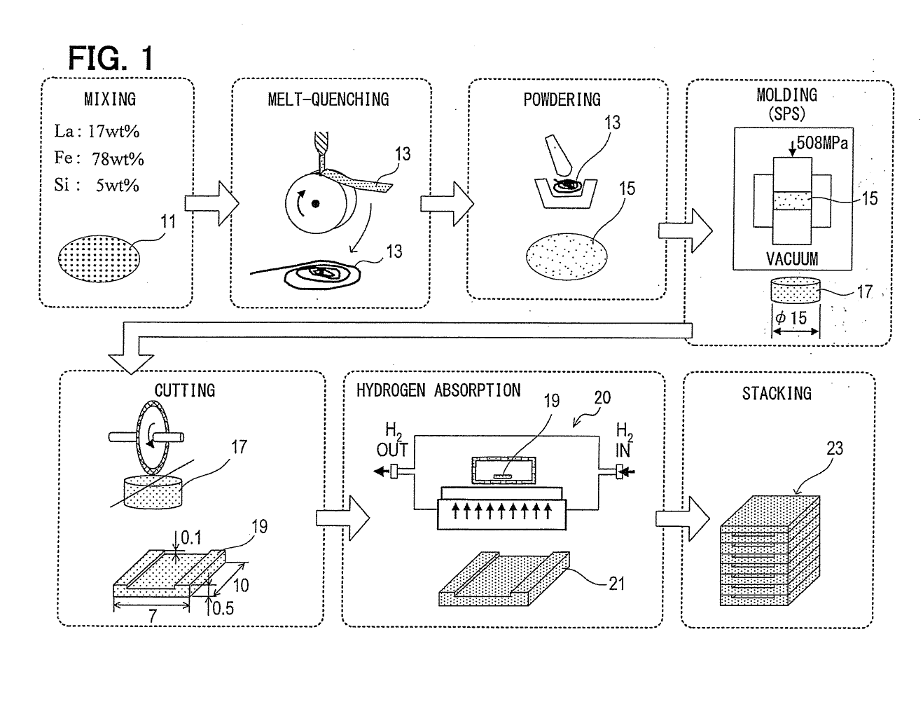

A manufacturing process of a micro-channel heat exchanger of an example 1 will be described with reference to FIG. 1. It is to be noted that FIG. 1 is a schematic diagram, and the size and the shape of each component in FIG. 1 may be different from an actual component.

(1) Mixing of Materials

Powders (or bulks) of simple elements were prepared and mixed together at a predetermined ratio to obtain a powder material 11. An example of composition of the powder material 11 was as follows:
La: 17 wt %
Fe: 78 wt %
Si: 5 wt %

(2) Melt-Quenching

Using the powder material 11, a band-shaped foil 13 made of an alloy having a crystalline structure of NaZn₁₃ was produced by a melt-quenching (strip casting).

(3) Powdering

The foil 13 was powdered to obtain a powder 15.

In a subsequent molding step, among particles of the powder 15, particles having a particle diameter of 214 micrometers (μm) or less were used.

(4) Molding

The powder 15 was compressed and heated using a discharge plasma sintering (SPS) apparatus. Thus, a molded product 17 having a bulked- or solid shape was produced. For example, the molded product 17 had a columnar shape with a diameter of 15 millimeters (mm).

In this step, the heating temperature applied to the material was 600° C. and the pressure applied to the material was 508 MPa. After the temperature of the material reached 600° C., the material was maintained in that state for ten minutes.

In this case, processing conditions are different from a general discharge plasma sintering method. In particular, the heating temperature is lower than the heating temperature of the general discharge plasma sintering method, and the applied pressure is higher than the applied pressure of the general discharge plasma sintering method.

Also in the following examples, the heating and compressing time after the temperature of the material reaches the target temperature was ten minutes.

After the molding step, a filling rate of the magnetic refrigeration material (molded product 17) was 82.1%. The filling rate was calculated based on “(actually measured density/theoretical density)×100(%)”, in which the theoretical density is 7.2 g/cm³.

Also in the following examples, the filling rate means the filling rate after the molding step.

(5) Cutting

A material piece 19 was produced by cutting, grinding and polishing the molded product 17 of the magnetic refrigeration material. The material piece 19 has a rectangular plate shape with the size of 7 mm (width)×10 mm (length)×0.5 mm (thickness). Further, the material piece 19 has a groove with a depth of 0.1 mm.

(6) Hydrogen Absorption

The material piece 19 was placed in a hydrogen furnace (flow furnace) 20 and heated at a temperature of 180° C. to 300° C. to absorb hydrogen. Thus, a material piece 21 of the magnetic refrigeration material to which the hydrogen was absorbed was produced. In this case, the amount of absorption of the hydrogen can be controlled by controlling the temperature of heat treatment.

(7) Stacking

The material pieces 21 were stacked. The stacked material pieces 21 were impregnated with thermosetting two-liquid mixing epoxy resin and solidified by curing through a heat treatment. Thus, a micro-channel heat exchanger 23 in which the grooves function as micro-channels was produced. In this case, the material piece 21 stacked at an uppermost layer did not have the groove.

Through the steps (1) to (7) described above, the micro-channel heat exchanger 23 using the magnetic refrigeration material was manufactured.

### Example 2

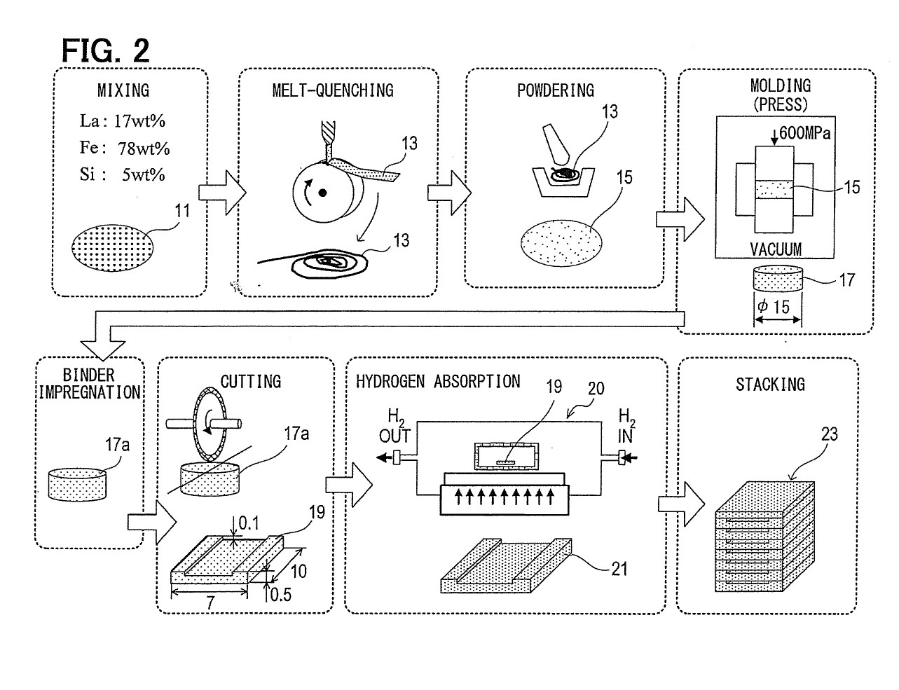

FIG. 2 is a diagram illustrating a manufacturing process of an example 2. In the example 2, a micro-channel heat exchanger 23 was manufactured in a similar manner to the example 1 except for the molding step of the above-described (4) and the impregnation treatment of the epoxy resin. In the molding step, a pressing apparatus was used, in place of the SPS apparatus. In the molding step, the heating temperature was 100° C., and the applied pressure was 600 MPa.

After the molding step, the molded product 17 was impregnated with a thermosetting two-liquid mixing epoxy resin as a binder, and cured by a heat treatment. Thus, a molded product 17a was produced. The cutting step and subsequent steps were performed in the similar manner to the example 1. In this case, the epoxy resin was added so that the content of the epoxy resin is 2 wt % of a total of the epoxy resin and the molded product 17.

### Example 3

In an example 3, a micro-channel heat exchanger was manufactured by a manufacturing process similar to the example 1 except that, in the molding step, the applied pressure was 286 MPa.

### Example 4

In an example 4, a micro-channel heat exchanger was manufactured by a manufacturing process similar to the example 1 except that, in the molding step, the heating temperature was 500° C. and the applied pressure was 286 MPa.

### Example 5

In an example 5, a micro-channel heat exchanger was manufactured by a manufacturing process similar to the example 1 except that, in the molding step, the heating temperature was 500° C.

### Example 6

In an example 6, a micro-channel heat exchanger was manufactured by a manufacturing process similar to the example 1 except that, in the molding step, the heating temperature was 100° C.

### Example 7

In an example 7, a micro-channel heat exchanger was manufactured by a manufacturing process similar to the example 1 except that, in the molding step, the pressing apparatus was used in place of the SPS apparatus. Further, in the molding step, the heating temperature was 100° C. and the applied pressure was 700 MPa.

### Comparative Example 1

In a comparative example 1, a micro-channel heat exchanger was manufactured by a manufacturing process similar to the example 1 except that, in the molding step, the heating temperature was 1100° C. and the applied pressure was 42 MPa.

### Comparative Example 2

In a comparative example 2, a micro-channel heat exchanger was manufactured by a manufacturing process similar to the example 1 except that, in the molding step, the heating temperature was 950° C. and the applied pressure was 42 MPa.

### Comparative Example 3

In a comparative example 3, a micro-channel heat exchanger was manufactured by a manufacturing process similar to the example 1 except that, in the molding step, the heating temperature was 900° C. and the applied pressure was 42 MPa.

### Comparative Example 4

In a comparative example 4, a micro-channel heat exchanger was manufactured by a manufacturing process similar to the example 1 except that, in the molding step, the heating temperature was 700° C. and the applied pressure was 42 MPa.

In the comparative example 4, the molded product 17 was cracked or crumbled in the cutting of the above-described step (5). Therefore, it was difficult to produce the material piece 19 having the plate shape with the thickness of 0.5 mm from the molded product 17.

### Comparative Example 5

In a comparative example 5, a micro-channel heat exchanger was manufactured by a manufacturing process similar to the example 1 except for the molding step. In particular, among the particles of the powder 15 produced by the powdering step, particles having a particle diameter of 25 μm or less was used in the molding step to produce the molded product 17. Further, in the molding step, the heating temperature was 700° C., and the applied pressing was 42 MPa.

### Comparative Example 6

In a comparative example 6, a micro-channel heat exchanger was manufactured by a manufacturing process similar to the example 1 except that, in the molding step, the heating temperature was 600° C. and the applied pressure was 42 MPa.

In the comparative example 6, the molded product 17 was cracked or crumbled during the cutting of the above-described step (5). Therefore, it was difficult to produce the material piece 19 having the plate shape with the thickness of 0.5 mm.

### Comparative Example 7

A micro-channel heat exchanger of a comparative example 7 was manufactured by a manufacturing process similar to the example 1 except that, in the molding step, the heating temperature was 500° C. and the applied pressure was 42 MPa.

In the comparative example 7, the molded product 17 was cracked or crumbled during the cutting of the above-described step (5). Therefore, it was difficult to produce the material piece 19 having the plate shape with the thickness of 0.5 mm from the molded product 17.

### Comparative Example 8

In a comparative example 8, a micro-channel heat exchanger was manufactured by a manufacturing process similar to the example 1 except that, in the molding step, the heating temperature was 30° C. and the applied pressure was 42 MPa.

In the comparative example 8, the molded produce 17 was cracked or crumbled during the cutting of the above-described step (5). Therefore, it was difficult to produce the material piece 19 having the plate shape with the thickness of 0.5 mm from the molded product 17.

### Comparative Example 9

In a comparative example 9, a micro-channel heat exchanger was manufactured by a manufacturing process similar to the example 1 except that, in the molding step, the heating temperature was 1100° C. and the applied pressure was 62 MPa.

### Comparative Example 10

In a comparative example 10, a micro-channel heat exchanger was manufactured by a manufacturing process similar to the example 1 except that, in the molding step, the heating temperature was 700° C. and the applied pressure was 286 MPa.

### Comparative Example 11

In a comparative example 11, a micro-channel heat exchanger was manufactured by a manufacturing process similar to the example 1 except that, in the molding step, the heating temperature was 100° C. and the applied pressure was 100 MPa.

In the comparative example 11, the molded produce 17 was cracked or crumbled during the cutting of the above-described step (5). Therefore, it was difficult to produce the material piece 19 having the plate shape with the thickness of 0.5 mm from the molded product 17.

<Evaluation of Molded Product>

Table 1 shows manufacturing conditions of the examples 1 to 7 and the comparative examples 1 to 11, the filling rate of the molded product 17, moldability, and the magneto-caloric effect ΔS (J/kg·K).

In regard to the evaluation of the moldability, “2” indicates a case where the material piece 19 having the plate shape with the thickness of 0.5 mm was produced by the cutting step without causing cracks and the like. Also, “1” indicates a case where the material piece 19 was produced by the cutting step although few cracks ware generated. “0” indicates a case where the molded product 17 was crumbled or large cracks were generated in the molded product 17 during the cutting.

TABLE 1

| | Temp | Pressure | Diameter | | | Filling | | ΔS |
|---|---|---|---|---|---|---|---|---|
| | (° C.) | (MPa) | (<μm) | Binder | Apparatus | rate (%) | Moldability | (J/kg · K) |
| Ex 1 | 600 | 508 | 214 | — | SPS | 82.1 | 1 | 12 |
| Ex 2 | 100 | 600 | 214 | Used | PRESS | 77.1 | 2 | 16 |
| Ex 3 | 600 | 286 | 214 | — | SPS | 79.9 | 1 | — |
| Ex 4 | 500 | 286 | 214 | — | SPS | 74.6 | 1 | — |
| Ex 5 | 500 | 508 | 214 | — | SPS | 77.7 | 1 | — |
| Ex 6 | 100 | 508 | 214 | — | SPS | 75.3 | 1 | — |
| Ex 7 | 100 | 700 | 214 | — | PRESS | 77.4 | 1 | — |
| Comp Ex 1 | 1100 | 42 | 214 | — | SPS | 95.4 | 2 | 9 |
| Comp Ex 2 | 950 | 42 | 214 | — | SPS | 81.0 | 2 | 9 |
| Comp Ex 3 | 900 | 42 | 214 | — | SPS | 80.0 | 1 | 9 |
| Comp Ex 4 | 700 | 42 | 214 | — | SPS | 72.0 | 0 | 9 |
| Comp Ex 5 | 700 | 42 | 25 | — | SPS | 64.6 | 2 | 9 |
| Comp Ex 6 | 600 | 42 | 214 | — | SPS | 71.3 | 0 | 14 |
| Comp Ex 7 | 500 | 42 | 214 | — | SPS | 70.2 | 0 | 16 |
| Comp Ex 8 | 30 | 42 | 214 | — | SPS | — | 0 | 16 |
| Comp Ex 9 | 1100 | 62 | 214 | — | SPS | 99.0 | 2 | 9 |
| Comp Ex 10 | 700 | 286 | 214 | — | SPS | 80.9 | 2 | 9 |
| Comp Ex 11 | 100 | 100 | 214 | — | SPS | 68.4 | 0 | — |

In the examples 1 to 7, since the applied pressure was 286 MPa or more, that is, in a range from 286 MPa to 700 MPa, the molding was implemented by setting the heating temperature at 600° C. or less, that is, in a range from 100° C. to 600° C. The magneto-caloric effect of the molded products by the examples 1 and 2 is higher than that of the molded products by the comparative examples 1 to 5, 9 and 10 in which the heating temperature of the molding step was 700° C. or more.

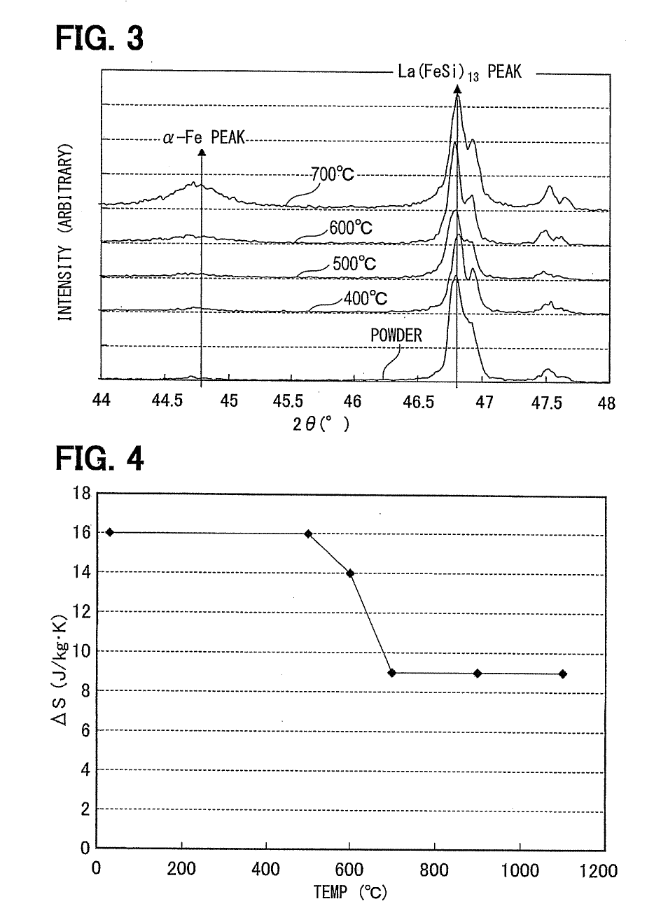

To examine a relationship between the amount of deposition of the α-Fe and the heating temperature, the content of the α-Fe of molded products that were produced by heating at a temperature in a range from 400° C. to 700° C. in the manufacturing method of the example 1 and the content of α-Fe of the powder before the heat treatment were determined by a X-ray diffraction (XRD) method. The determination results are shown in FIG. 3.

As shown in FIG. 3, the amount of deposition of the α-Fe is very small in the molded products produced by heating at the temperature equal to or lower than 600° C. However, the amount of deposition of the α-Fe is high in the molded products produced by heating at the temperature of 700° C.

As such, it is appreciated that the deposition of the α-Fe can be reduced by setting the heating temperature during the molding at 600° C. or less.

A relationship between the treatment temperature (heating temperature) of the comparative examples 1 to 7 and the magneto-caloric effect ΔS (J/kg·K) is shown in FIG. 4.

As shown in FIG. 4, the magneto-caloric effect reduces with an increase in the heating temperature. In the examples 1 to 7, the molding is performed at the heating temperature equal to or less than 600° C. Therefore, the decrease of the magneto-caloric effect ΔS can be suppressed.

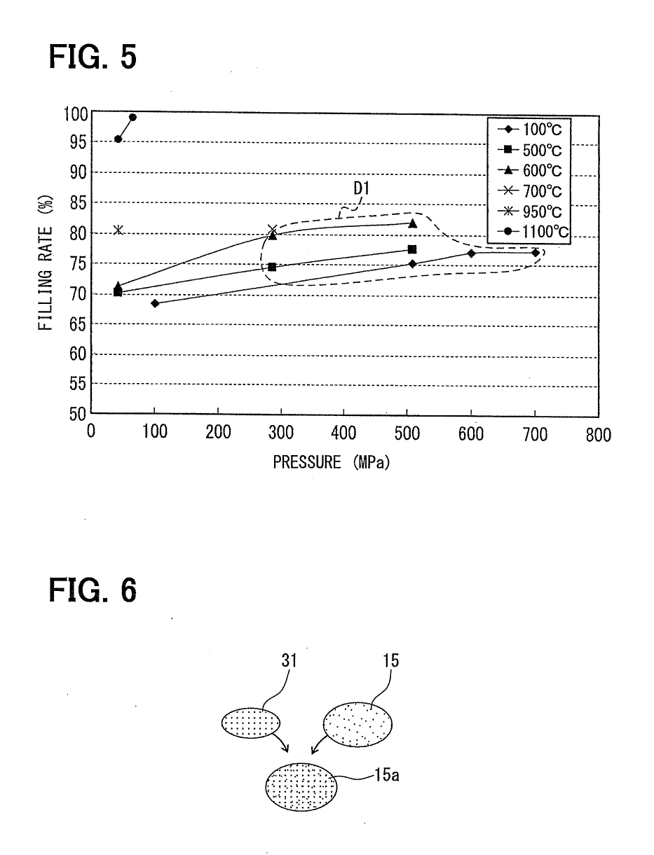

A relationship between the applied pressure and the filling rate of the examples 1 to 7 and some of the comparative examples is shown in FIG. 5. Data encompassed by a dashed line D1 shows the results of the examples.

As shown in FIG. 5, when the applied pressure is 500 MPa or more, the filling rate is increased to 75% or more. The filling rate linearly increases up to approximately 500 MPa. The rate of the increase in the filling rate reduces from approximately 500 MPa and more. Further, the rate of the increase in the filling rate becomes very small from 700 MPa and more.

Therefore, when the material is compressed by a pressure in the range from 500 MPa to 700 MPa, the filling rate can be effectively increased. The magneto-caloric effect increases with the increase in the filling rate. As such, when the material is compressed by the pressure in the range from 500 MPa to 700 MPa, the molded product having the high magneto-caloric effect can be produced.

As shown in the result of the example 2, when the molded product is impregnated with the binder, such as the two-liquid mixing thermosetting epoxy resin, the moldability improves. In the example 2, the epoxy resin was added so that the content of the epoxy resin is 2 wt % of the total weight of the molded product and the epoxy resin. If the content of the epoxy resin excessively increases, the filling rate of the magnetic refrigeration material reduces. When the content of the epoxy resin is 10 wt % or less, preferably, in a range from 1 to 5 wt %, the moldability improves while reducing the decrease in the magneto-caloric effect.

<Other Manufacturing Methods>

The examples of the present disclosure were described hereinabove. However, the present disclosure may not be limited to the above-described examples, but various modifications will be applicable to the manufacturing method within a technical scope of the present disclosure.

For example, in the example 2, the two-liquid mixing thermosetting epoxy resin is used as the binder. However, the binder may not be limited to the two-liquid mixing thermosetting epoxy resin. For example, any other resin, adhesive agent, or conductive adhesive agent may be used as the binder impregnated into the molded product.

An example of the conductive adhesive agent is a mixture of metal powder, such as silver, copper, or aluminum, and an organic solvent or a resin. The conductive adhesive agent exerts a conductivity through metal powder after adhesion.

The adhesive agent and the conductive adhesive agent may be added so that its content is 10 wt % or less, particularly, in a range from 1 wt % to 5 wt % approximately.

After the powdering of the above-described step (3), a powder 15a may be produced by adding a metal powder 31 to the powder 15 for assisting bonding of the powder 15. The molding step may be performed using the powder 15a. As the metal powder 31, for example, α-Fe, copper or aluminum may be used. The metal powder 31, such as α-Fe, copper, or aluminum, may be added to the powder material to be molded in the molding step so that the content of the metal powder 31 is 2 wt % or less of the material. In this case, a bonding effect is sufficiently achieved. Preferably, the content of the metal powder 31 is in a range from 0.1 wt % to 1 wt %.

In the examples 1 to 7, the micro-channel heat exchanger 23 was produced using the molded product 17. The manufacturing method of the present disclosure may be employed to manufacture a molded product used for any devices other than the micro-channel heat exchanger.

As described above, in the manufacturing method, a powder material made of La (Fe, Si)₁₃ is molded by applying a pressure equal to or higher than 286 MPa at a heating temperature equal to or lower than 600° C. Thus, a molded product of the magnetic refrigeration material is produced.

Since the powder material of the magnetic refrigeration material is molded by applying the pressure while heating at the temperature which is in a range where the amount of deposition of α-Fe is relatively small. Therefore, since the amount of deposition of the α-Fe is decreased, it is less likely that the magneto-caloric effect will be decreased. Since the heating temperature is low so as to reduce the deposition of the α-Fe, progression of the sintering reaction is slow. However, since the powder material is applied with a high pressure, the molding of the powder material is realized.

Steps before and after the molding may not be particularly limited. A step of generating the powder material before the molding, a step of cutting the molded product, a step of absorbing hydrogen and the like may be arbitrarily performed.

After the molding, the molded product may be impregnated with a binder. As the binder, resin powder such as an epoxy resin, an adhesive agent such as conductive adhesive agent, may be used.

In the molding, a metal powder for assisting the bonding of the powder material may be added to the powder material. In such a case, the metal powder may be powder of α-Fe, copper powder, or aluminum powder.

While only the selected exemplary embodiment and examples, have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiment and examples according to the present disclosure is provided for illustration only, and not for the purpose of limiting the disclosure as defined by the appended claims and their equivalents.

What is claimed is:

1. A manufacturing method of a magnetic refrigeration material, the method comprising:
molding a powder material made of La (Fe, Si)₁₃ by applying a pressure equal to or higher than 286 MPa and heating at a temperature equal to or lower than 600 degrees Celsius, thereby to produce a molded product of the magnetic refrigeration material.

2. The manufacturing method according to claim 1, further comprising impregnating a binder into the molded product.

3. The manufacturing method according to claim 2, wherein the binder includes an epoxy resin.

4. The manufacturing method according to claim 1, wherein
in the molding, a metal powder is added to the powder material to assist bonding of the powder material.

5. The manufacturing method according to claim 1, wherein the molding is performed by discharge plasma sintering.
